(19) United States
(12) Patent Application Publication
(10) Pub. No.: US 2011/0137720 A1
(43) Pub. Date: Jun. 9, 2011

(54) SYSTEM AND METHOD OF SUPPORTING A COMMUNITY BASED PROGRAM, INCREASE BUSINESS FOR LOCAL MERCHANTS, AND INCREASE USE OF FINANCIAL CARDS

(76) Inventor: Larry J. Kane, Marion, IA (US)

(21) Appl. No.: 12/633,064

(22) Filed: Dec. 8, 2009

(51) Int. Cl. G06Q 30/00; G06Q 50/00; G06Q 40/00

(52) U.S. Cl. 705/14.34

(57) ABSTRACT

A system and method where a give back program is offered to a merchant who signs-up for the program by accessing a website provided by an independent third party service provider. The merchant inputs information including purchase criteria. A cardholder uses a financial card for a transaction with the merchant and the transaction information is transmitted to a financial institution.

The financial institution transmits a transaction file to the third party service provider where a rebate is debited from the merchant's financial account based upon a comparison of the transaction file with the purchase criteria. The distribution of the rebate is made based upon distribution information from the cardholder or distribution criteria from the financial institution.

### BACKGROUND OF THE INVENTION

This invention is directed toward a system for promoting use of a financial card and more particularly promoting use of financial cards at designated merchants while also providing financial support to worthy causes in a community.

Financial cards offering rewards are known in the industry, as are financial cards that provide means to contribute to charitable organizations. While beneficial, existing reward cards fail to coordinate the efforts of multiple organizations in increasing business for local merchants, develop customer loyalty and increased revenue for financial institutions, provide savings and benefits for financial cardholders, and provide financial support to worthy community causes. In particular, existing programs fail to permit merchants to easily set and change participation criteria, permit cardholders to easily control and change reward criteria, and accommodate both participating and non-participating cardholders. Accordingly, a need exists in the art for a system and method that addresses these deficiencies. An objective of the present invention is to provide a method and system where merchants and cardholders agree to participate in a give back program.

Another objective of the present invention is to provide a method and system where merchants and cardholders can easily set and change criteria for a give back program.

A still further objective of the present invention is to provide an incentive to a promotional organization to recruit merchants and cardholders for a give back program.

Another objective of the present invention is to provide a method and system of coordinating a give back program utilizing financial cards from both participating and non-participating cardholders.

A still further objective is to provide a method and system of providing a give back program where the activities and interests of a financial institution, a promoting organization, a financial cardholder and a community organization are coordinated and monitored by a third party service provider.

These and other objectives will become apparent to those skilled in the art based upon the following written description.

### SUMMARY OF THE INVENTION

A system and method where a give back program is offered to a merchant who signs-up for the program by accessing a website provided by an independent third party service provider. The merchant inputs information including purchase criteria. A cardholder uses a financial card for a transaction with the merchant and the transaction information is transmitted to a financial institution.

The financial institution transmits a transaction file to the third party service provider where a rebate is debited from the merchant's financial account based upon a comparison of the transaction file with the purchase criteria. The distribution of the rebate is made based upon distribution information from the cardholder or distribution criteria from the financial institution.

### BRIEF DESCRIPTION OF THE DRAWINGS

FIG. 1 is a schematic drawing of a system for increasing use of a financial card; and

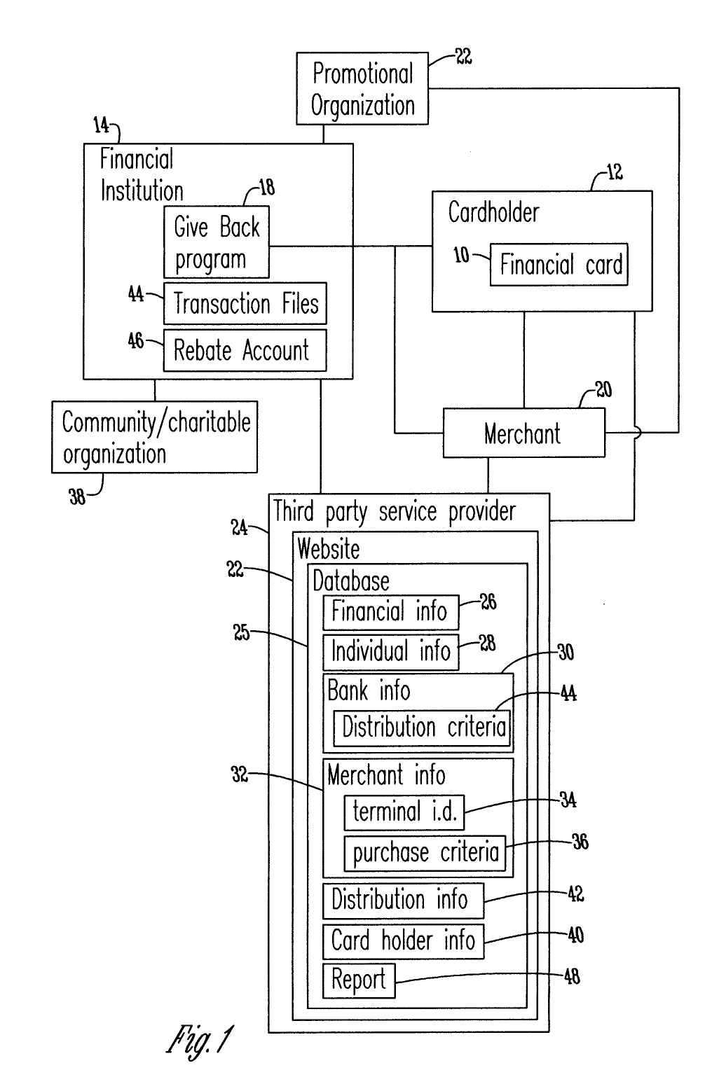

FIG. 2 is a flow diagram of a method for increasing use of a financial card.

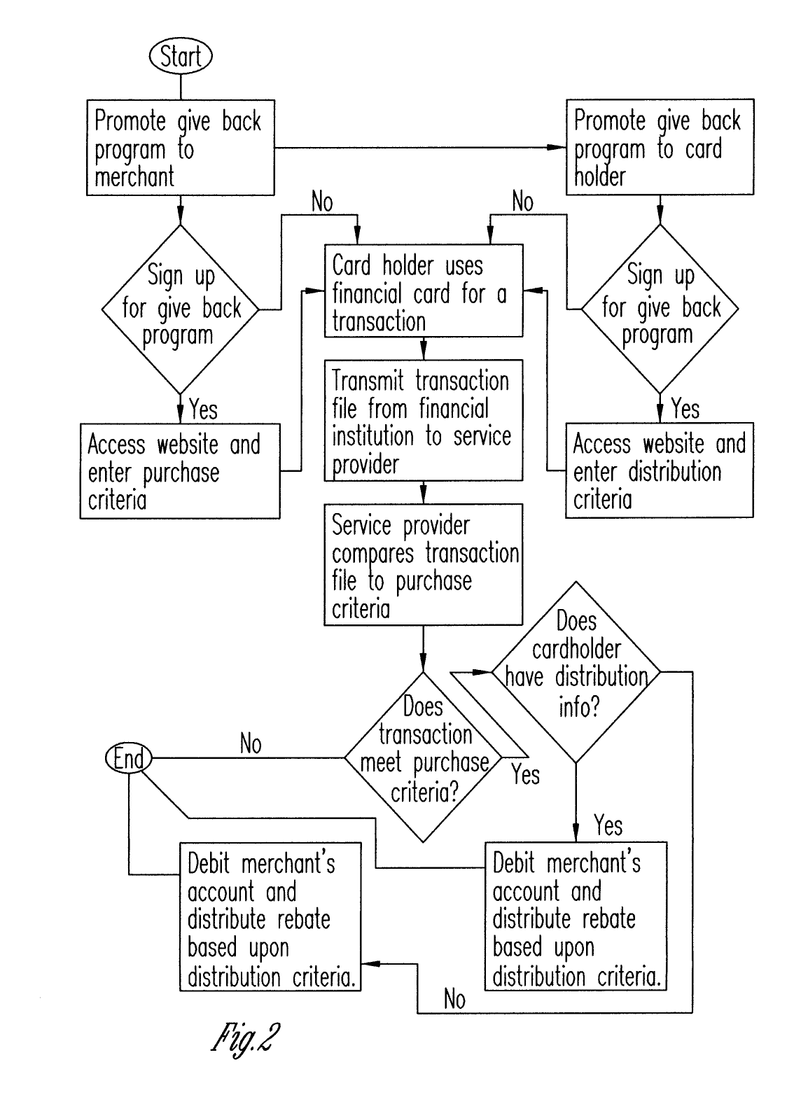

### DETAILED DESCRIPTION OF THE PREFERRED EMBODIMENT

Referring to the Figures, the method and system is centered upon the use of a financial card 10 (i.e. debit card) by a cardholder 12. Typically, the financial card is issued by a financial institution 14 such as a bank or credit union for use by the cardholder 12 at a variety of merchants 20. The method and system includes use of new and existing financial cards 10.

The method and system includes promotion of a give back program 18 to merchants 20 who preferably are locally owned. While the financial institution 14 may promote participation in the program 18, other promotional organizations 22 such as a chamber of commerce, a sales organization, a charitable organization or the like may also promote the program 18 to a merchant 20. In return for promoting the organization 22 would receive a commission for each merchant that signs up. By participating in the program 18, a merchant 20 is permitted to advertise that a rebate will be provided to a cardholder 12 based upon selected purchases.

To sign-up for the program 18, the merchant 20 accesses a website 22 over an electronic network provided by a non-financial third party service provider 24. The third party service provider 24 is an independent organization that maintains a database 25 containing financial 26 and individual 28 information of cardholders, bank information 30, and merchant information 32. After entering merchant information 32 into the website 22, the merchant provides terminal identification information 34 for various stores and sets purchase criteria 36. Purchase criteria 36 includes things such as minimum purchase amount, rebate percentage, maximum rebate amount, and starting and ending dates for the rebate. For example, a hardware store could set purchase criteria to include a 5 percent rebate on purchases of at least $25 with a maximum rebate amount of $50. The purchase criteria 36 can be changed at any time by the merchant 20 simply by entering the website 22 and changing the purchase criteria.

The program 18 is also promoted to cardholders 12 by the financial institution 14. By signing up for the program 18 the cardholder 12 is able to designate all or a portion of the rebate to one or more community and/or charitable organizations 38 or keep the rebate for their own use. The cardholder 12 signs up for the program by accessing the third party service provider's 24 website 22 and inputting cardholder information 40 such as the financial card number along with distribution information 42 designating how the rebate is to be distributed. The distribution information can be changed by the cardholder 12 at any time simply by accessing the website 22.

Should a cardholder elect not to sign-up for the program 18 the rebate is distributed based upon the financial institution's distribution criteria 44. For example, the financial institution 14 may elect to distribute all of the rebate to one or more community and/or charitable organizations 38 or distribute all or a portion of the rebate to the cardholder 12.

When transactions occur, transactions are processed in a conventional manner where funds are debited from the cardholder's 12 financial account and transferred to the merchant's 20 financial account. The financial institution 14 transmits, via an electronic network, daily transaction files 44 to the third party service provider 24 that includes information such as the transaction date and amount. The third party service provider then compares the daily transaction files 44 with information stored within its database 25. Based upon this comparison, the third party service provider 24 determines which transactions occurred at a participating merchant 20 and which of those transactions meet the merchant's 20 purchase criteria 36. When a transaction meets the purchase criteria 36 a rebate is debited from the merchant's 20 financial account and held in a rebate account 46 for distribution.

A report 48 is generated from the transactions that meet the purchasing criteria 36 which can be accessed by the cardholder 12 and displayed on the website 22. The report 48 preferably lists each transaction for which a rebate was given.

At the end of a period (i.e., month), preferably designated by the financial institution, the total rebate amount for each cardholder 12 is transferred from the rebate account to the cardholders 12 financial account or the organizations 38 account based upon the cardholder's 12 distribution information 42 or the banks distribution criteria 44. In addition, the cardholder 12 receives a statement which indicates the total rebate given for the period.

Thus, a method and system has been disclosed that at the very least meets all of the stated objectives.

What is claimed is:

1. A method of increasing use of a financial card, comprising the steps of:
promoting a give back program to merchants who sign-up for the program by accessing a website provided by a third-party service provider over an electronic network;
entering merchant information, terminal identification information, and purchase criteria into a database connected to the website;
processing a transaction using a financial card of a cardholder that is stored in a transaction file;
transmitting the transaction file via the electronic network to the third party service provider;
debiting a rebate from a merchant's financial account based on a comparison of the transaction file and the stored purchase criteria.

2. The method of claim 1 wherein the purchase criteria comprises a minimum purchase amount, a rebate percentage, a maximum rebate amount, and a starting and an ending date for the rebate.

3. The method of claim 1 further comprising the step of promoting the give back program to the cardholder whereby the cardholder signs up for the program by accessing the website via the electronic network and entering distribution information.

4. The method of claim 3 wherein the distribution information includes distribution of a portion of the rebate to a community/charitable organization.

5. The method of claim 1 further comprising the step of distributing the rebate based upon a financial institution's distribution criteria.

6. A system for increasing the use of a financial card comprising:
a third-party service provider having a website connected to an electronic network;
a merchant who provides merchant information, terminal identification, and purchase criteria to the third-party service provider via the website on the electronic network;
a cardholder who uses a financial card for a transaction with the merchant that is transmitted via the electronic network to a financial institution; and
wherein the financial institution transmits a transaction file to the third party service provider where a rebate is debited from a merchant's financial account based upon a comparison of the transaction file and the purchase criteria.

7. The system of claim 6 wherein the comparison of the transaction file and the purchase criteria includes a comparison of a financial card number, a transaction date, and a transaction amount with the purchase criteria.

8. The system of claim 6 wherein the purchase criteria comprises a minimum purchase amount, a rebate percentage, a maximum rebate amount, and a starting and an ending date for the rebate.

9. The system of claim 6 wherein the cardholder inputs distribution information into the website.

10. The system of claim 9 wherein a portion of the rebate is distributed to a community/charitable organization based upon the cardholder's distribution information.

11. The system of claim 6 wherein a financial institution inputs distribution criteria to the website.

12. The system of claim 11 wherein the rebate is distributed based upon the distribution criteria.

13. The system of claim 6 wherein the comparison of the transaction file with the purchase criteria includes a comparison with the terminal identification.
